(19) United States
(12) Patent Application Publication
(10) Pub. No.: US 2009/0263015 A1
(43) Pub. Date: Oct. 22, 2009

(54) Method And Apparatus For Correcting Underexposed Digital Images

(76) Inventor: Guoyi Fu, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/104,881

(22) Filed: Apr. 17, 2008

(51) Int. Cl. H04N 5/228

(52) U.S. Cl. 382/167

(57) ABSTRACT

A method of correcting an underexposed digital image comprises determining the stop of underexposure at which the digital image was captured, correcting for one integer stop of underexposure iteratively until the amount of underexposure correction is equal to the integer component of the determined stop of underexposure and correcting for any remaining fractional component of the determined stop of underexposure.

### FIELD OF THE INVENTION

The present invention relates generally to digital image processing and in particular, to a method and apparatus for correcting an underexposed digital image.

### BACKGROUND OF THE INVENTION

Digital cameras have an ISO rating identifying their level of sensitivity to light. For most digital cameras, a default ISO 100 setting is normal although some digital cameras have default ISO settings as low as fifty (50). The PENGUIN® digital camera board produced by Seiko Epson Corporation has an ISO range between fourteen (14) and nine-hundred and ten (910) and a default ISO 50 setting. In high-end digital, single-lens reflex (SLR) cameras, even higher ISO settings are available. For example, in some digital SLR cameras, the default ISO setting can be set to 200, 400, 800 or even 3200.

During image capture, the image sensor of the digital camera is exposed to incoming light that passes through the lens of the digital camera. The red, green and blue color channel values output by the image sensor are conveyed to analog-to-digital converters (ADCs), which in turn output raw digital image color value data to a processor. The processor in response, processes the raw digital image data to form the resultant captured image and stores the image in memory. The amount of light that the image sensor is exposed to for a given captured image is controlled by the speed setting of the shutter and the setting of the aperture. As is well known, for a fixed aperture setting, increasing the shutter speed decreases the amount of light the image sensor is exposed to during image capture. Similarly, for a fixed shutter speed setting, increasing the aperture setting decreases the amount of light the image sensor is exposed to during image capture. In order to capture properly exposed images, the shutter speed and aperture settings for the digital camera need to be selected so that, for the ambient light level, the image sensor is exposed to the proper amount of incoming light each time the digital camera is conditioned to capture an image. If the image sensor is exposed to too much light during image capture, the resultant captured image will be overexposed (i.e. too bright) and if the image sensor is exposed to too little light during image capture, the resultant captured image will be underexposed (i.e. too dark).

In order to correct an underexposed digital image, it is necessary to brighten the digital image to the level of a properly exposed image with minimum color degradation. Brightening an underexposed digital image in this manner is challenging due to the fact that an underexposed image contains less information than a properly exposed image. This is a result of quantization error and the fact that low image sensor output color values can be rounded to zero (0) by the ADCs.

Quantization error occurs because the output color values of the image sensor lie in smaller ranges for an underexposed digital image than for a properly exposed image. Typically for a properly exposed digital image, the color values for each color channel lie in the range from zero (0) to two-hundred and fifty-five (255). For an underexposed digital image, because the image sensor is exposed to a reduced amount of incoming light, the color values for each color channel lie in a significantly smaller range. For example, for an underexposed digital image it is not uncommon for the color values for each color channel to lie in the range from zero (0) to one-hundred and twenty-seven (127). In the above example, scaling the smaller color value range (0 to 127) to the full range (0 to 255) poses a problem in that each color value of the smaller range can be mapped to one of two values of the larger range resulting in a loss of information. This loss of information or quantization error is particularly noticeable when significantly unexposed (i.e. very dark) images are scaled to brighten them.

Although quantization error is undesired, a more serious problem occurs when the color values for one or more color channels are very low. In this situation, the ADCs may round the color values down to a zero (0) value. As will be appreciated, when this occurs, it is impossible to recover the lost image color information.

Given the problems associated with scaling underexposed digital images to brighten them as discussed above, it is not surprising that other techniques for correcting underexposed digital images have been considered. For example, U.S. Pat. No. 6,956,967 to Gindele et al. and U.S. Patent Application Publication No. 2003/0234944 to Gindele disclose a method for transforming the color appearance of a digital image that corrects for underexposure problems associated with the photographic response of a capture medium. Color pixel information from a plurality of digital images on the same capture medium is used in order to develop a color correction transform. A non-linear adjustment corrects an underexposed condition as a function of the capture medium. A linear functional relationship dependent on the pixels of the basic color defines an exposure-level-dependent estimate of grey corresponding to the photographic response of the capture medium. A color sensitometry transform removes absolute density and slope differences between red, green and blue response curves due to spectrosensitivities of the film scanner hardware not being well matched. The net effect of the color sensitometry correction is to correct the color of pixels to a greater degree the farther they are from a grey balance point.

U.S. Pat. No. 6,370,265 to Bell et al. discloses a method for generating a greyscale transfer curve for use in deriving a lookup table, given certain input parameters representing desirable contrast and brightness characteristics. An “s” shaped curve models the transfer function and its features may be controlled by parameters representing transfer curve x and y boundary conditions, the location of the curve along the x-axis and the slope of the curve.

U.S. Patent Application Publication No. 2004/0258324 to Liang et al. discloses a method for dynamically enhancing the contrast of an image captured with a digital camera. A brightness distribution histogram is computed in order to obtain a corresponding relationship between a grey level value and a pixel count. The brightness distribution histogram is divided into four areas and a transfer curve is computed for equalizing the brightness histogram thereby to enhance the contrast in the captured image.

U.S. Patent Application Publication No. 2005/0220359 to Sun et al. discloses a method for improving the quality of images that have been blurred or underexposed. During the method, two images having different exposure intervals are taken of the same scene so that one image is underexposed and the other image is blurred. The time lapse between capture of the two images is kept short in order to minimize any differences in the captured scene. The two images are related entirely in their color space by performing a transformed histogram equalization. Spatial regions in the images are matched and, in combination with the color space relationship, the underexposed image is enhanced.

U.S. Patent Application Publication No. 2005/0265599 to Huang et al. discloses a method for controlling image contrast. During the method, a grey level value of at least one pixel is obtained and used to calculate a probability function of that grey level value in a predetermined range. The probability function is used to determine the adjustment of the grey level value and to adjust a transfer curve between grey level minimum and maximum values.

U.S. Patent Application Publication No. 2005/0276507 to White discloses a method and system for performing exposure or white balance correction. An approximation to a log of illumination based on incorporated constants and an input pixel intensity value is calculated. Using the approximation, a target pixel intensity is determined. The response characteristics of digital cameras are modelled in quadratic form with constants that are typically specific to each digital camera.

U.S. Pat. No. 6,462,835 to Loushin et al. discloses an imaging system and method that produces correction lookup tables for each of red, green and blue separations of scanned color images from calibration curves. A tone curve optimization algorithm measures the darkest useable portion and the lightest exposed portion of the film in n-bit space. The range between these measured portions is then scaled using a gamma correction curve in order to map the range to a 2 m level space for use during correction.

U.S. Pat. No. 6,473,199 to Gilman et al. discloses a method for providing improved prints by a printer from images captured over a wide range of exposure conditions. A plurality of exposure and tone scale correction algorithms, each one unique to an exposure condition, is computed using input LAB values obtained from patches on a test target with a reflection densitometer.

U.S. Pat. No. 6,706,485 to Gilman et al. discloses a method for correcting exposure in an image captured with a digital camera. A user-controlled adjustment causes the image data to be modified using a lookup table such that the modified digital image appears as if the digital camera had provided a correspondingly higher exposure level than that at which the digital camera had captured the image. During the method, exposure correction is first applied to the uncorrected full resolution red, green and blue (RGB) image using a first lookup table. The output of the first lookup table is then input to a second lookup table which performs a printing correction.

U.S. Pat. No. 6,826,310 to Trifonov et al. discloses a method for automatically enhancing contrast in a digital image. During the method, the digital image data is represented in the form of a brightness histogram and a measure of central tendency (MCT) of the histogram is determined. The MCT is shifted to provide an adjusted MCT and the original and adjusted MCTs are used to determine the exponent of a non-linear histogram transformation. The histogram transformation is applied to all brightness values in the digital image so as to convert the brightness histogram in such a way that it would have approximated the adjusted MCT after transformation.

Although the above references discuss techniques to compensate for underexposed images, improvements are continually being sought. It is therefore an object of the present invention to provide a novel method and apparatus for correcting an underexposed digital image.

### SUMMARY OF THE INVENTION

Accordingly, in one aspect there is provided a method of correcting a digital image captured at a stop of underexposure comprising:

for a first integer component of said arbitrary stop of underexposure, applying a first transfer function to recorded values of said digital image, said first transfer function representing a mapping of recorded image values of the digital image underexposed by the first integer component to true image values had the digital image been properly exposed; and

repeating the applying of the first transfer function to the recorded image values of the digital image for each other equal integer component of said arbitrary stop of underexposure

In one embodiment, following the repeating, a second transfer function is applied to the recorded image values to account for a fractional component of the stop of underexposure if it exists. In one form, the first integer component of the stop of underexposure is one integer stop of underexposure. The first transfer function is a piecewise linear transfer function and comprises a steep low intensity segment, a shallow medium intensity segment and a flat high intensity segment.

According to another aspect there is provided a method for correcting an underexposed digital image comprising:

determining the stop of underexposure at which the digital image was captured;

correcting for one integer stop of underexposure iteratively until the amount of underexposure correction is equal to the integer component of the determined stop of underexposure; and

correcting for any remaining fractional component of the determined stop of underexposure.

During the correcting, for each color channel of the digital image, a mapping of recorded color values of the digital image to true color values in a correction lookup table is adjusted and wherein following the mapping adjusting, each recorded color value is looked up in the correction lookup table to determine its corrected true color value. The determined true color values are used to update the recorded color values.

According to yet another aspect there is provided an apparatus for correcting an underexposed digital image, said computer program comprising:

an apparatus for correcting an underexposed digital image comprising:

memory storing recorded color values of the underexposed digital image; and

processing structure communicating with said memory, said processing structure determining the stop of underexposure at which the digital image was captured; correcting for one integer stop of underexposure iteratively until the amount of underexposure correction is equal to the integer component of the determined stop of underexposure; and correcting for any remaining fractional component of the determined stop of underexposure.

### BRIEF DESCRIPTION OF THE DRAWINGS

Embodiments will now be described more fully with reference to the accompanying drawings in which:

FIG. 1 is a schematic diagram of a digital SLR camera;

FIG. 2 is a flowchart showing the steps performed during digital image underexposure correction;

FIG. 3 is a flowchart showing the steps performed during correction lookup table generation;

FIG. 4 is a test pattern image;

FIG. 5 shows plots of recorded digital image color values versus true color values for three different stops of underexposure in three color channels at ISO 50 and ISO 910 settings;

FIG. 6 is a graph showing a curve from which a one stop of underexposure transfer function f₋₁(r) is derived;

FIG. 7 is a graph showing application of the transfer function f₋₁(r) to the recorded green color values of the ISO 910 image data of FIG. 5 to correct for two stops of underexposure; and

FIG. 8 shows graphs comparing predicted and actual recorded color value versus true color value curves for each color channel at various stops.

### DETAILED DESCRIPTION OF THE EMBODIMENTS

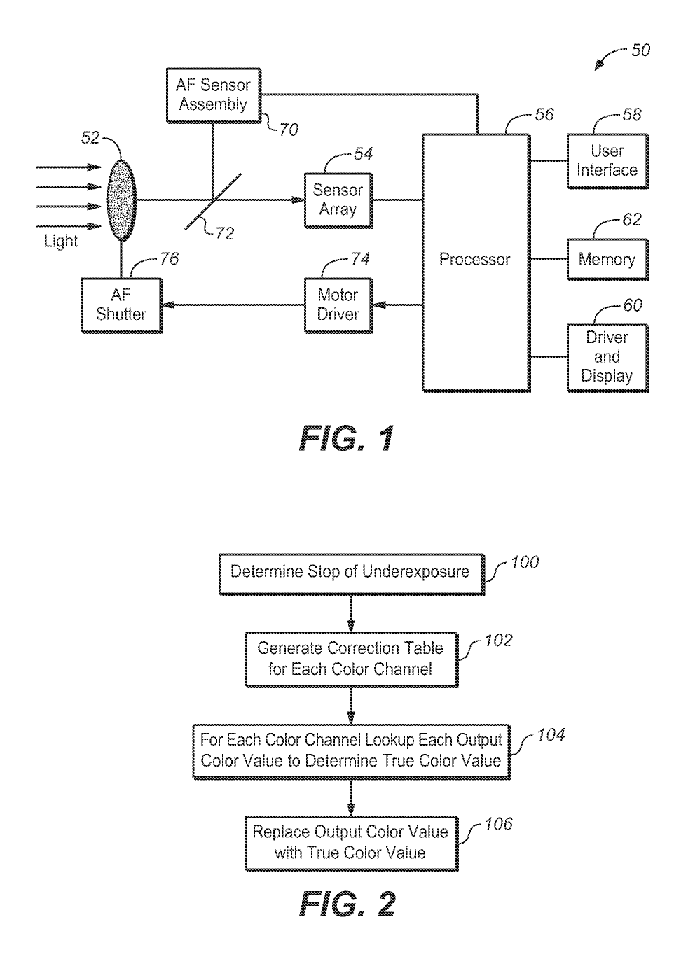

Turning now to FIG. 1, a simplified schematic diagram of an image capture device in the form of a digital SLR camera is shown and is generally identified by reference numeral 50. Digital camera 50 comprises a lens assembly 52 that focuses incoming light onto a CCD or CMOS image sensor array 54 of a PENGUIN® digital camera board when an image is to be captured. As mentioned above, the PENGUIN® digital camera board has an ISO range from fourteen (14) to nine-hundred and ten (910) and a default ISO 50 setting. The image sensor array 54 in turn provides red, green and blue color value image data to analog to digital converters (not shown). A processor 56 processes the raw digital image color value data received from the analog to digital converters to form a resultant captured digital image. Processor 56 also communicates with a user interface 58 comprising control buttons, switches, rockers etc. that allow a user to operate the digital camera 50, a driver and associated display 60 and memory 62.

The digital camera 50 in this embodiment also includes a phase detection autofocus (AF) system comprising an AF sensor assembly 70. A mirror 72 reflects light entering the digital camera 50 via the lens assembly 52 towards the AF sensor assembly 70 when an image is not being captured. Light directed to the AF sensor assembly 70 by the mirror 72 is divided into two paths and directed onto its right and left image sensors via associated lenses (not shown). The processor 56 communicates with the AF sensor assembly 70 and with a motor driver 74 and AF shutter 76 in a known manner thereby to provide the digital camera 50 with the autofocus feature.

The processor 56 in this embodiment executes an exposure correction application to brighten underexposed captured digital images based on an underexposure transfer curve model calibrated to one (1) integer stop f₋₁ of underexposure. The transfer curve model is designed to correct moderate underexposure at high ISO settings. Further specifics concerning the exposure correction application will now be described.

Turning now to FIG. 2, when an underexposed digital image is captured by the digital camera 50, the stop of underexposure at which the digital image was captured is determined (step 100). Based on the determined stop of underexposure, a correction lookup table is generated for each of the red, green and blue color channels (step 102). Each correction lookup table comprises a mapping of each possible recorded color value of the associated color channel to its true color value representing what the recorded color value would have been had the digital image been captured at the proper exposure. Once the correction lookup tables have been generated for each color channel, each color value output by the image sensor is looked up in its associated correction lookup table to determine the true color value for that color value (step 104). The determined true color value is then used to replace the color value (step 106). As a result, each underexposed color value in the digital image is replaced with a color value representing what the recorded color value would have been had the digital image been captured at the proper exposure. This process allows the underexposed digital image to be brightened using a simple lookup table process.

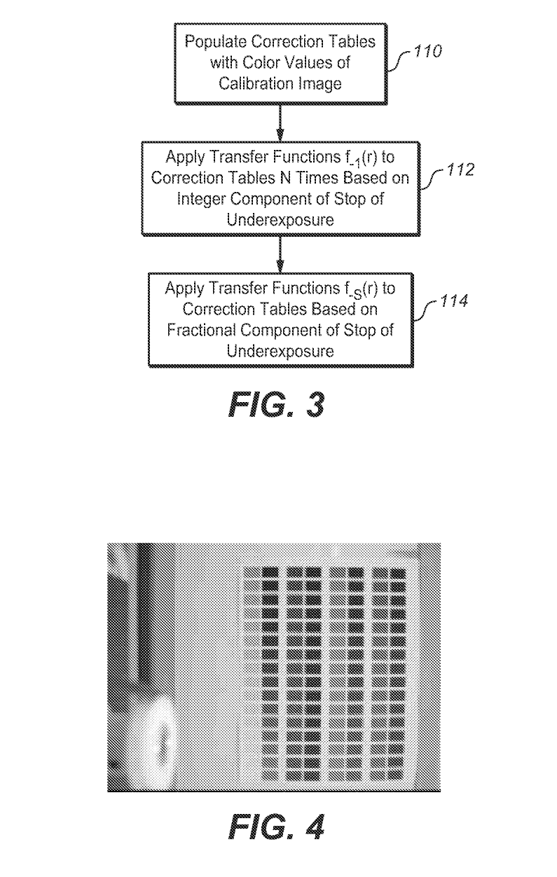

During generation of each correction lookup table at step 102, initially each correction lookup table is populated using the recorded color values from the associated color channel of a calibration image captured at the stop f₀ of proper exposure (step 110 in FIG. 3). In this case, as the calibration image is a properly exposed digital image, each recorded color value maps to a true color value that is equal to the recorded color value. A transfer or correction function f₋₁(r) that maps recorded color values (r) captured at one (1) integer stop f₋₁ of underexposure to their true color values is then applied to each correction lookup table N times in succession, where N represents the integer component of the stop of underexposure determined at step 100. As a result, the mapping of the recorded color values to the true color values in each correction lookup table is adjusted (step 112). Thus, for example, if the underexposed digital image was captured at one (1) integer stop f₋₁ of underexposure, the transfer function f₋₁(r) is applied to each initially populated correction lookup table once. If the underexposed digital image was captured at three (3) integer stops f₋₃ of underexposure, the transfer function f₋₁(r) is applied to each correction lookup table three consecutive times. The correction lookup table generation process thus assumes that applying the transfer function f₋₁(r) representing one stop of underexposure twice, gives a good approximation of the transfer function f₋₂(r) representing two stops of underexposure correction, applying the transfer function f₋₁(r) representing one stop of underexposure three times, gives a good approximation of the transfer function f₋₃(r) representing three stops of underexposure correction etc.

After the transfer function f₋₁(r) has been applied to each correction lookup table N times, a fractional transfer function f₋₃(r) is calculated according to the following equation:

f₋ₛ(r)=−s•f₋₁(r)+(1+s)•f₀(r)

where:

is the fractional component of the stop of underexposure determined at step 100 having a value in the range of 0>s>−1; and

f₀(r) represents the mapping of the recorded color values of the calibration image to the true color values.

The fractional transfer function f₋ₛ(r) is then applied to each correction lookup table to adjust further the mapping of the recorded color values to the true color values thereby to complete the correction lookup table generation process (step 114).

Each transfer function f₋₁(r) is a three-piece linear function representing a curve having an initial steep segment corresponding to the low intensity range, a shallow intermediate segment corresponding to the middle intensity range and a flat segment corresponding to the high intensity saturation range and is of the form:

$${f}_{- 1} ( r ) \{ \begin{matrix}\frac{r}{{r}_{1}} \cdot {t}_{1} & 0 \leq r \leq {r}_{1} \\ \frac{r - {r}_{1}}{{r}_{2} - {r}_{1}} \cdot ( 255 - {t}_{1} ) + {t}_{1} & {r}_{1} \leq r \leq {r}_{2} \\ 255 & {r}_{2} \leq r \leq 255\end{matrix}$$

were:

r₁ is the recorded color value at the transition point between the initial steep segment and the shallow intermediate segment;

t₁ is the true color value corresponding to the recorded color value r₁; and

r₂ is the recorded color value at the transition point between the shallow intermediate segment and the flat segment.

In order to determine the parameters r₁, t₁, and r₂ for a given digital camera, only two calibration images are required, namely a properly exposed digital image (i.e. a digital image captured at stop f₀) and a digital image captured at one stop f₋₁ of underexposure. The parameters r₁, t₁, and r₂ for each transfer function are selected for the digital camera either manually or automatically by minimizing the error in the approximation of the transfer function using a least squares statistical fit. For the PENGUIN® digital camera board, the values assigned to the parameters r₁, t₁, and r₂ for each transfer function are set out in Table 1 below:

TABLE 1

| | Red | Green | Blue |
|---|---|---|---|
| r₁ | 55 | 64 | 60 |
| t₁ | 117 | 124 | 130 |
| r₂ | 196 | 198 | 222 |

In order to determine the transfer functions for the color channels of the image sensor, images of a test pattern comprising colored and grey squares as shown in FIG. 4 were captured using the digital camera 50 at various stops and ISO speeds and analyzed. In particular, two image sets, one image set at the default ISO 50 speed and one image set at the maximum ISO 910 speed, were captured. Each image set included twelve (12) images taken at intervals of ⅓ stop between 0 (normal properly exposed) and −3⅔ (nearly thirteen times underexposed).

As the grey squares covered a wider range of recorded color values in the red, green and blue color channels only the recorded color values corresponding to the grey squares were used. To minimize the effect of noise, the average color of each grey square was computed. Each test pattern image thus yielded thirty-two (32) data points for each color channel, corresponding to the thirty-two grey squares. The resultant dataset was stored as a 32×12×3 matrix (thirty-two squares×twelve images×three color channels).

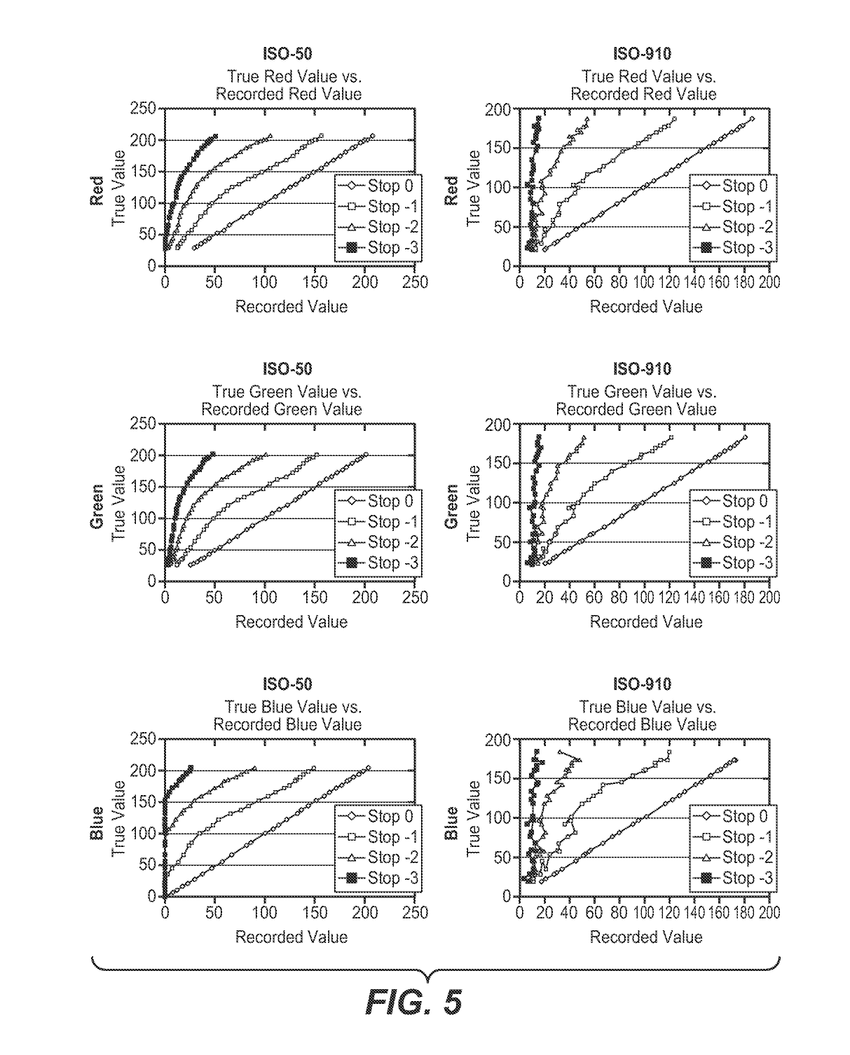

The recorded test pattern image color values versus the true color values for stops f₋₀, f₋₁, f₋₂ and f₋₃ of underexposure in the three color channels, at each of the two ISO settings were plotted as shown in FIG. 5.

As will be appreciated, the graphs of FIG. 5 provide interesting information. Firstly, in the blue channel, for the normal ISO 50 setting, all the recorded color values below a threshold (which depends on the stop of underexposure) have a zero value. This occurs because the magnitudes of the recorded blue color values are so small that the recorded color values are quantized to zero during analog to digital conversion.

The recorded color values for the high ISO 910 setting are noisier than the corresponding recorded color values for the normal ISO 50 setting, representing the noise associated with the high gain setting. The recorded color values at these two ISO settings however still show a correspondence between true color values and recorded color values at the stop f₋₂ of underexposure. Below the stop f₋₂ of underexposure, correspondence becomes less significant. As can be seen, at the stop f₋₃ of underexposure, the recorded color value data forms nearly vertical lines as a result of signal degradation and noise.

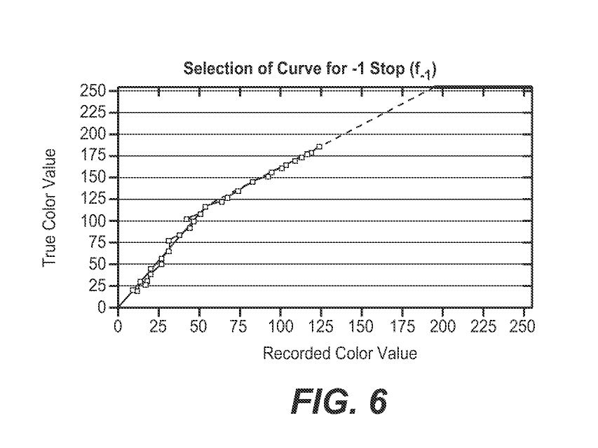

As will be apparent from FIG. 5, each of the plotted curves for the stop f₋₁ of underexposure has a similar shape comprising the initial steep low intensity segment, the shallow intermediate medium intensity segment and the flat saturation high intensity segment. The properties of each curve depend mainly on the stop of underexposure, and vary only slightly between color channel and ISO settings. FIG. 6 is a graph showing the curve from which the three-piece linear function discussed previously was derived. In this example, at one stop f₋₁ of underexposure the division between the initial steep and intermediate shallow segments occurs at a recorded color value of between 45 and 60, saturation occurs at a true color value of between 180 and 220, the initial steep segment has a slope of between 1.9 and 2.2, and the intermediate shallow segment has a slope of between 0.75 and 1, for all color channels and at both ISO settings.

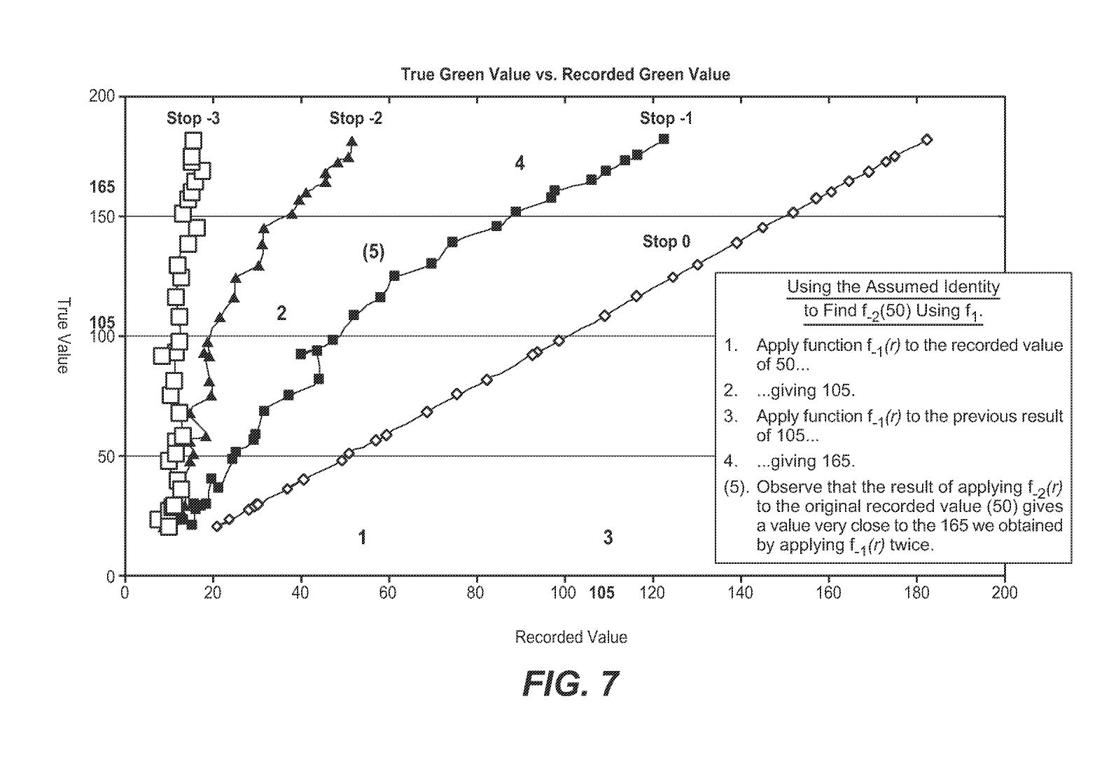

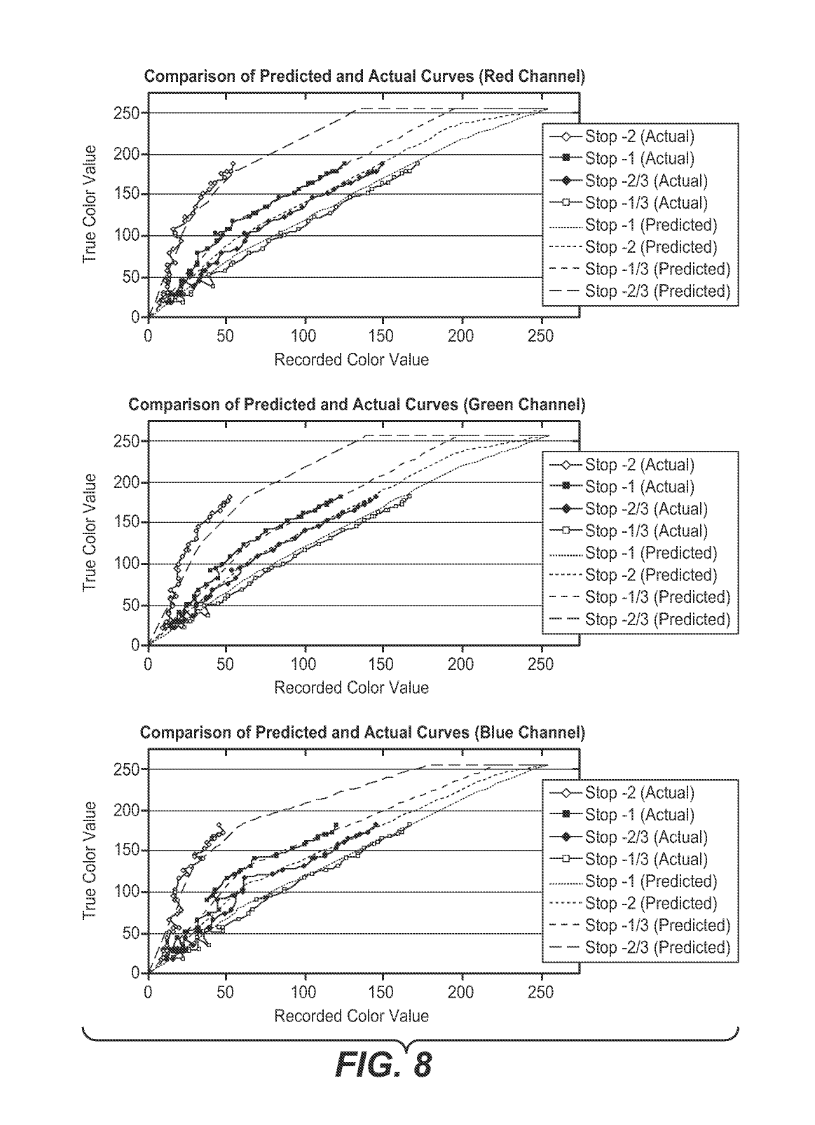

FIG. 7 is a graph showing application of the transfer function f₋₁(r) to the recorded green color values of the ISO 910 image dataset twice to correct for two stops f₋₂ of underexposure. As will be appreciated, applying the transfer function f₋₁(r) twice yielded a result that was very close to that achieved by applying a f₋₂(r) transfer function. FIG. 8 shows graphs comparing predicted and actual recorded color value versus true color value curves for each color channel at various stops. Again as will be appreciated, the predicted and actual color value curves are similar.

The underexposure correction application provides advantages in that it is easy to calibrate due to the fact that only three (3) parameters need to be chosen and only two (2) calibration images are required. Also, as correction lookup tables are employed, underexposure correction can be performed quickly even for large images without affecting image quality.

If information concerning the digital camera is not available, transfer functions f₋₁(r) based on default curves may be used. For example, default curves having a steep low intensity segment extending from recorded color values in the range of 0 to 55 and a slope equal to two (2), an intermediate shallow medium intensity segment extending from recorded color values in the range of 56 to 200 and a slope equal to one (1) and a flat saturation high intensity segment extending from recorded color values in the range of 200 to 255 and a slope of zero (0) may be employed.

The exposure correction application may comprise program modules including routines, programs, object components, data structures etc. and be embodied as computer-readable program code stored on a computer-readable medium. The computer-readable medium is any data storage device that can store data, which can thereafter be read by a computer system. Examples of computer-readable medium include for example read-only memory, random-access memory, hard disk drives, magnetic tape, CD-ROMs and other optical data storage devices. The computer-readable program code can also be distributed over a network including coupled computer systems so that the computer-readable program code is stored and executed in a distributed fashion.

While the exposure correction application is described and illustrated as being executed by the processor of a digital camera, those of skill in the art will appreciate that the exposure correction application may be employed in other image capture devices such as for example digital scanners, facsimile machines, photocopiers etc.

Although particular embodiments have been described, those of skill in the art will also appreciate that variations and modifications may be made without departing from the spirit and scope thereof as defined by the appended claims.

What is claimed is:

1. A method of correcting a digital image captured at an arbitrary stop of underexposure comprising:
for a first integer component of said arbitrary stop of underexposure, applying a first transfer function to recorded values of said digital image, said first transfer function representing a mapping of recorded image values of the digital image underexposed by the first integer component to true image values had the digital image been properly exposed; and
repeating the applying of the first transfer function to the recorded image values of the digital image for each other equal integer component of said arbitrary stop of underexposure.

2. The method of claim 1 further comprising, following said repeating, applying a second transfer function to the recorded image values to account for a fractional component of said stop of underexposure if it exists.

3. The method of claim 2 wherein said first integer component of said stop of underexposure is one (1) integer stop of underexposure.

4. The method of claim 3 wherein said first transfer function is a piecewise linear transfer function.

5. The method of claim 4 wherein said first transfer function comprises a steep low intensity segment, a shallow medium intensity segment and a flat high intensity segment.

6. The method of claim 5 wherein said first transfer function is of the form:
$${f}_{- 1} ( r ) \{ \begin{matrix}\frac{r}{{r}_{1}} \cdot {t}_{1} & 0 \leq r \leq {r}_{1} \\ \frac{r - {r}_{1}}{{r}_{2} - {r}_{1}} \cdot ( 255 - {t}_{1} ) + {t}_{1} & {r}_{1} \leq r \leq {r}_{2} \\ 255 & {r}_{2} \leq r \leq 255\end{matrix}$$
where:
r₁ is the recorded image value at the transition point between the initial steep segment and the shallow intermediate segment;
t₁ is the true image value corresponding to the recorded image value r₁; and
r₂ is the recorded image value at the transition point between the shallow intermediate segment and the flat segment.

7. The method of claim 6 wherein said second transfer function is of the form:
f₋ₛ(r)=−s•f₋₁(r)+(1+s)•f₀(r)
where:
s is the fractional component of the stop of underexposure having a value in the range of 0>s>−1; and
f₀(r) represents the mapping of the recorded image values of a properly exposed digital image to the true color values.

8. A method of correcting an underexposed digital image comprising:
determining the stop of underexposure at which the digital image was captured;
correcting for one integer stop of underexposure iteratively until the amount of underexposure correction is equal to the integer component of the determined stop of underexposure; and
correcting for any remaining fractional component of the determined stop of underexposure.

9. The method of claim 8 wherein during said correcting, for each color channel of said digital image, a mapping of recorded color values of the digital image to true color values in a correction lookup table is adjusted and wherein following the mapping adjusting, each recorded color value is looked up in the correction lookup table to determine its corrected true color value, the determined true color values being used to update the recorded color values.

10. The method of claim 9 wherein said correcting for one integer stop of underexposure comprises applying a piecewise linear transfer function to the mappings.

11. The method of claim 10 wherein said linear transfer function comprises a steep low intensity segment, a shallow medium intensity segment and a flat high intensity segment.

12. The method of claim 11 wherein said linear transfer function is of the
form:
$${f}_{- 1} ( r ) \{ \begin{matrix}\frac{r}{{r}_{1}} \cdot {t}_{1} & 0 \leq r \leq {r}_{1} \\ \frac{r - {r}_{1}}{{r}_{2} - {r}_{1}} \cdot ( 255 - {t}_{1} ) + {t}_{1} & {r}_{1} \leq r \leq {r}_{2} \\ 255 & {r}_{2} \leq r \leq 255\end{matrix}$$
where:
r₁ is the recorded color value at the transition point between the initial steep segment and the shallow intermediate segment;
t₁ is the true color value corresponding to the recorded color value r₁; and
r₂ is the recorded color value at the transition point between the shallow intermediate segment and the flat segment.

13. The method of claim 12 wherein said correcting for the remaining fractional component comprises applying to the mappings a second transfer function of the form:
f₋ₛ(r)=−s•f₋₁(r)+(1+s)•f₀(r)
where:
s is the fractional component of the stop of underexposure having a value in the range of 0>s>−1; and
f₀(r) represents the mapping of the recorded color values of a properly exposed digital image to the true color values.

14. An apparatus for correcting an underexposed digital image comprising:
memory storing recorded color values of the underexposed digital image; and
processing structure communicating with said memory, said processing structure determining the stop of underexposure at which the digital image was captured; correcting for one integer stop of underexposure iteratively until the amount of underexposure correction is equal to the integer component of the determined stop of underexposure; and correcting for any remaining fractional component of the determined stop of underexposure.

15. An apparatus according to claim 14 wherein said processing structure, for each color channel of said digital image, adjusts a mapping of recorded color values of the digital image to true color values in a correction lookup table stored in said memory, looks up each recorded color value in the correction table to determine its corrected true color value, and uses the determined true color values to update the recorded color values.

16. An apparatus according to claim 15 embodied in one of a digital camera, digital scanner, facsimile machine and photocopier.

17. An apparatus according to claim 16 wherein during correction for one integer stop of underexposure, said processing structure adjusts the mapping using a piecewise linear transfer function.

18. An apparatus according to claim 17 wherein said linear transfer function comprises a steep low intensity segment, a shallow medium intensity segment and a flat high intensity segment.

19. An apparatus according to claim 18 wherein said linear transfer function
is of the form:
$${f}_{- 1} ( r ) \{ \begin{matrix}\frac{r}{{r}_{1}} \cdot {t}_{1} & 0 \leq r \leq {r}_{1} \\ \frac{r - {r}_{1}}{{r}_{2} - {r}_{1}} \cdot ( 255 - {t}_{1} ) + {t}_{1} & {r}_{1} \leq r \leq {r}_{2} \\ 255 & {r}_{2} \leq r \leq 255\end{matrix}$$
where:
r₁ is the recorded color value at the transition point between the initial steep segment and the shallow intermediate segment;
t₁ is the true color value corresponding to the recorded color value r₁; and
r₂ is the recorded color value at the transition point between the shallow intermediate segment and the flat segment.

20. An apparatus according to claim 19 wherein said processing structure, to correct for the remaining fractional component, applies a second transfer function to the mappings of the form:
f₋ₛ(r)=−s•f₋₁(r)+(1+s)•f₀(r)
where:
s is the fractional component of the stop of underexposure having a value in the range of 0>s>−1; and
f₀(r) represents the mapping of the recorded color values of a properly exposed digital image to the true color values.

21. A computer readable medium embodying a computer program for correcting an underexposed digital image, said computer program comprising computer program code for carrying out the method of claim 1.

22. A computer readable medium embodying a computer program for correcting an underexposed digital image, said computer program comprising computer program code for carrying out the method of claim 8.
